(19) United States
(12) Patent Application Publication
(10) Pub. No.: US 2026/0185531 A1
(43) Pub. Date: Jul. 2, 2026

(54) Method for Information Exchange Between an External Recipient and a Pump

(71) Applicant: KSB SE & Co. KGaA, Frankenthal (DE)

(72) Inventors: Daniel GONTERMANN, Frankenthal (DE); Patrick HAUCK, Frankenthal (DE); Christoph KOEHLER, Frankenthal (DE); Benedikt MUELLER, Frankenthal (DE); Jochen SCHAAB, Frankenthal (DE); Patrick SCHMITT, Frankenthal (DE); Sebastian MEISINGER, Frankenthal (DE)

(21) Appl. No.: 19/124,736

(22) PCT Filed: Oct. 12, 2023
(86) PCT No.: PCT/EP2023/078315

§ 371 Date: Apr. 25, 2025

(30) Foreign Application Priority Data
Oct. 28, 2022 (DE) 10 2022 128 744.0

(51) Int. Cl. F04D 27/00; F04D 25/06; H02K 11/35

(52) U.S. Cl. CPC F04D 27/00; F04D 25/06; H02K 11/35

(57) ABSTRACT

A method for information exchange between an external receiver and a pump includes providing an electric motor as pump drive and a frequency inverter for the speed-regulated control of the motor. The pump generates an acoustic information signal that is detectable by the external receiver. The method also includes varying at least one operating parameter of the frequency inverter while the pump is operating normally, in such a manner that the pump, while it is operating normally, delivers an acoustic information signal that is detectable by the external receiver.

### CROSS REFERENCE TO RELATED APPLICATION

This application is a 371 National Stage Application of PCT/EP2023/078315, filed Oct. 12, 2023, which claims priority from German Patent Application No. 102022128744.0, filed Oct. 28, 2022, the entire disclosure of which is herein expressly incorporated by reference.

### BACKGROUND

The disclosure relates to a method for information exchange between an external receiver and a pump comprising an electric motor as pump drive and a frequency inverter for the speed-regulated control of the motor, wherein the pump generates an acoustic information signal that is detectable by the external receiver.

Modern pumps, for example heating circulator pumps, are nowadays operated in a speed-regulated manner for efficiency reasons. The pump drive in the form of an electric motor is supplied by means of a frequency inverter. The output voltage generated by the frequency inverter, which is supplied to the motor as motor voltage, can be changed in order to adjust the speed.

As well as the energy-efficient control of the pumps, it is additionally increasingly important to create a communication link between the pump and at least one external receiver for the purposes of information exchange. The external receiver can be a central control or administration unit or simply a commercially available smartphone or tablet running an application for communication with the pump. Operating data of the pump are to be transmitted via the interface for external monitoring, administration or control. In order for the pumps to be capable of communication, it is necessary to integrate separate communication hardware into the pump. It is known, for example, to integrate a Bluetooth communication module, but this is associated with increased production costs for the pump.

### SUMMARY

The object of the present disclosure consists in providing a simple and inexpensive communication possibility for a pump.

This object is achieved by a method for information exchange between an external receiver and a pump according to the features disclose herein. Advantageous embodiments of the method are subject matter of the present disclosure. The object is further achieved by a pump according to the present disclosure.

Starting from a known pump comprising an electric motor and a frequency inverter for regulating the speed of the pump, it is proposed to dispense with separate hardware for communication with at least one external receiver. Instead, the already existing hardware of the frequency inverter is to be used, other than as intended, for communication purposes, which is made possible by adapting the controller of the frequency inverter; in particular, a software-based control logic of the frequency inverter can easily be adapted.

According to the disclosure, it is proposed, concretely, to vary at least one operating parameter of the frequency inverter while the pump is operating, in such a manner that the pump, while it is operating, generates a dedicated acoustic signal that is clearly detectable by an external receiver. To put it simply, by purposively modifying the motor control, which does not notably influence the speed regulation, the normal operating noise of the pump is purposively changed, so that this can be recognized by an external receiver.

In this way, a simple possibility for information exchange between the pump and any desired receiver can be achieved. For most applications, the possibility so created is sufficient, for example, to signal an alarm or other pump status or condition. An existing pump does not require any supplementation in terms of hardware; instead, the programmatic adaptation of the frequency inverter is sufficient. Thus, existing pumps can also be retrospectively modified and retrofitted with a communication possibility.

For the implementation of the method, it must be ensured that the normal pump function is ideally not affected or at least is affected only slightly by the variation of the operating parameter of the frequency inverter.

According to an advantageous embodiment, the output voltage generated by the frequency inverter, that is to say the motor supply voltage, for example, can be changed, whereby a detectable acoustic signal is generated. For normal operation of the pump motor, the motor voltage is generated with a variable base frequency and amplitude at the output of the frequency inverter. Preferably, a voltage curve with a higher frequency than the base frequency, for example, can be impressed onto this voltage, that is to say a so-called high-voltage injection can be carried out by suitably controlling the frequency inverter. By suitably impressing a high-frequency voltage curve onto the motor voltage of base frequency, a definable acoustic signal that is detectable by the receiver can be generated while the pump is operating. This additional frequency modulation of the motor voltage has no impact or only a marginal impact on normal pump operation, so that the pump continues to function properly. By generating the acoustic signal by high-frequency injection, the pump is thus able, as required, to output an acoustic indication that is detectable by any terminal device equipped with an acoustic receiver.

Instead of the possibility of high-frequency injection, it is proposed in an advantageous embodiment of the disclosure to modify the switching frequency with which the integral switching elements of the inverter component of the frequency inverter are switched. Adapting the switching frequency generally has no impact on the output voltage that is generated, but it does lead to abnormal acoustic operating noise of the pump, which in turn is detectable as an information signal by a receiver.

It is conceivable, for example, that the switching elements are originally switched with a reference switching frequency that is usually constant. If a transmission of information from the pump to a receiver is pending, then the switching frequency is increased or reduced preferably by a defined amount. This deviation of the current switching frequency from an original reference switching frequency can be detected acoustically and thus recognized by a receiver. For example, in the case of an original reference switching frequency of 16 kHz, information such as, for example, an alarm could be signaled by the pump to a receiver by reducing the switching frequency to 15 kHz.

According to a further enhancement of the disclosure, the defined change in the switching frequency can also be used to transmit a binary data sequence from the pump to a receiver. For this purpose, the change in the switching frequency must be clocked, that is to say the change in the switching frequency must take place at defined times. If the receiver is synchronized with the temporal rate of change, a binary data sequence can be transmitted from the pump to the receiver.

The method according to the disclosure for information transmission can be used for various applications in which information is to be transmitted from the pump to at least one receiver. It is conceivable, for example, for the pump to transmit its current state by means of the method. Pump operation without modified operating parameters of the frequency inverter signals, for example, that the pump is in a correct functional state, while operation with a modified operating parameter and consequently generation of the acoustic signal is to indicate an anomaly in the pump behavior.

In practice, it is often of interest to the pump manufacturer for the pumps used by the customer to be registered, that is to say the pump manufacturer can uniquely link the pump with a specific customer identification so as thus to be able to provide dedicated customer service. It is advantageous here, for example, for the modification of the operating parameter to generate an acoustic signal by means of which it is indicated to a receiving device whether the pump has already been registered with the manufacturer or not. A dedicated application, executed on a smartphone, tablet or laptop, could in this way detect the acoustic signal in the receiving range and automatically assist the user with registering the pump. The application could also indicate to the customer whether the pump is operating properly or whether a defect is present.

For detecting and evaluating the acoustic signal, the external receiving device preferably uses a built-in, commercially available microphone. By means of audio analysis of the recorded audio signal, in particular by means of frequency analysis such as fast Fourier transformation (FFT) or discrete Fourier transformation (DFT), an application executed on the device is able to extract the transmitted information from the recorded audio signal.

The acoustic signal generated by means of the method can be audible to a human, so that a technical device is in principle not necessary for the information transmission, but the user can already recognize and ideally evaluate the changed operating noise of the pump. However, there is no reason why the modification of the operating parameter cannot be chosen such that a human is not able to perceive the change in the operating noise, that is to say the generated acoustic signal.

In addition to the method according to the disclosure, the disclosure relates also to a pump, in particular a centrifugal pump, comprising an electric motor and a frequency inverter for the speed-variable regulation of the electric motor. According to the disclosure, the frequency inverter, in particular the controller of the frequency inverter, is configured to carry out the steps of the method according to the disclosure. Consequently, the same advantages and properties as have already been discussed above in respect of the method are obtained for the pump according to the disclosure. A repeat explanation is omitted for the sake of simplicity.

The pump can be a heating circulator pump, a circulation pump for a pressure booster system or another kind of centrifugal pump. The electric motor is an inverter-controlled alternating current or three-phase motor. The method can generally be used for any types of motor that are controlled by means of a frequency inverter, such as, for example, synchronous and asynchronous motors, reluctance motors, synchronous reluctance motors, etc.

Further advantages and properties of the disclosure will be explained in greater detail below by means of the application steps set out in the figures, in which:

### BRIEF DESCRIPTION OF THE DRAWINGS

FIG. 1: shows a schematic diagram of the method steps according to a first application scenario, and

FIG. 2: shows a diagram of the schematic steps during a second application scenario.

### DETAILED DESCRIPTION

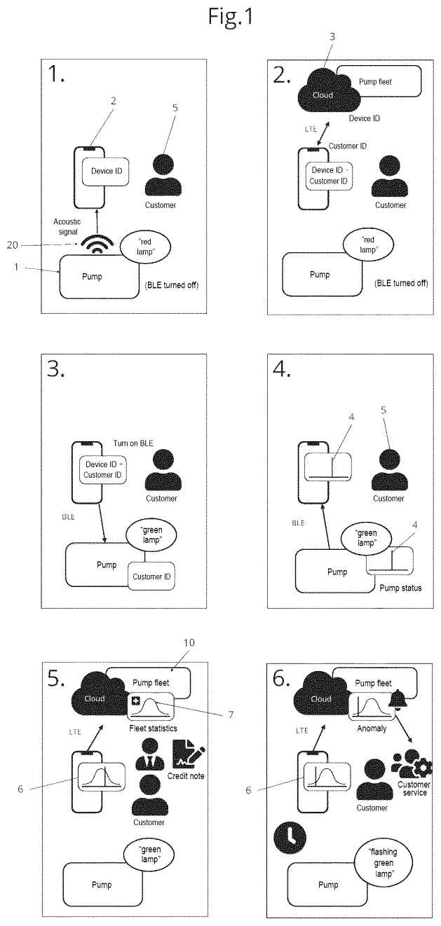

In the following, a possible application scenario for the method according to the disclosure is described. The pump 1 shown here is a heating circulator pump, which is installed in the heating system of the customer 5. The heating circulator pump 1 comprises an electric motor, which is regulated in an energy-efficient manner by means of an integrated frequency inverter. The method according to the disclosure is here used to allow status information to be outputted by the hardware of the pump 1, which information is then detectable by any desired terminal device 2. In the concrete exemplary embodiment, this status information, referred to hereinbelow as “acoustic red or green lamp”, indicates whether the pump 1 has been registered with the pump manufacturer 3 or not. The diagram of FIG. 1 shows the schematic steps for the registration process.

### Step 1

In the delivery state of the pump 1, the pump emits an acoustic signal 20 (“acoustic red lamp”), which can be recognized via the microphone of a smartphone 2 and which contains a DeviceID of the pump 1. The acoustic signal 20 is generated by means of the method according to the disclosure by varying an operating parameter of the built-in frequency inverter of the pump 1.

In addition to the voltage curve in a base frequency that is required for operation of the motor, it is here possible for an additional high-frequency voltage curve to be generated by the frequency inverter by means of a so-called high-frequency injection. This high-frequency voltage curve can be impressed in such a manner that an acoustic signal 20 is produced, which signal can be detected and evaluated by the smartphone 2 and the application installed thereon. In particular, the application carries out a real-time FFT analysis of the signal previously recorded via the microphone of the smartphone.

Alternatively, an acoustically detectable or perceptible signal 20 could be generated by varying the switching frequency of the frequency inverter, so that the deviation from a fixed reference frequency can be used for the transmission of information. In the case of a reference switching frequency of 16 kHz, a switching frequency of 15 kHz, for example, could signal that the pump 1 is not registered (“acoustic red lamp”). The base frequency for actual operation of the motor is usually in the range from 50 Hz to 300 Hz and is not affected by the variation of the switching frequency. If a fixed time window is specified for the variation between two or even more switching frequencies, then it is possible to send rudimentary digital information such as the DeviceID in the form of binary “1” and “0” as a “broadcast”.

When a corresponding application is carried out on the smartphone 2, the acoustic signal 20 can be evaluated and the pump 1 can be identified as a pump that has not yet been registered. Furthermore, the acoustic signal 20 can already contain the DeviceID of the pump 1, which the smartphone 2 receives and can use in the further process.

### Step 2

After the DeviceID of the pump 1 has been received by the smartphone 2, the user 5 is directed via the app on the smartphone 2 to register the pump 1 online. The link between the smartphone 2 and the cloud 3 can be effected at least partially by a mobile communication standard, for example LTE, or WLAN. The DeviceID is transmitted to a cloud server 3 of the pump manufacturer, where it is linked with a CustomerID.

### Step 3

After the CustomerID has been provided and linked with the DeviceID, the CustomerID is subsequently applied to the pump 1 via an optional additional digital communication link between the smartphone 2 and the pump 1 according to the Bluetooth/Bluetooth low energy standard. The acoustic signal 20 generated by the pump 1 changes to the “acoustic green lamp”, for example in that the variation of the operating parameter is cancelled. The transmission of the CustomerID to the pump 1 is only optional, however; alternatively, it could also be indicated to the pump 1 that the registration was successful by means of a manual input at the control panel of the pump.

### Step 4

The registered pump 1 sends an identifier of its health value 4 to the app of the smartphone 2, either likewise via the acoustic signal 20 or, preferably, via the Bluetooth link that has been established.

### Step 5

This health value 4 is sent by the smartphone 2 to the cloud 3. In the cloud 3, the transmitted health value 4 of the pump 1 is compared with the health values 7 of an anonymous fleet 10 of comparable pump models. The customer 5 subsequently receives an evaluation 6 of his own pump 1 compared to the anonymous fleet 10.

### Step 6

In the event of a fault or if an anomaly occurs, the acoustic signal 20 is again used to make the customer 5 aware of the anomaly of the pump 1. The acoustic “green lamp flashes” and thus signals an anomaly. Customer service 11 can then actively approach the customer 5 whose CustomerID is known and provide service for the pump 1.

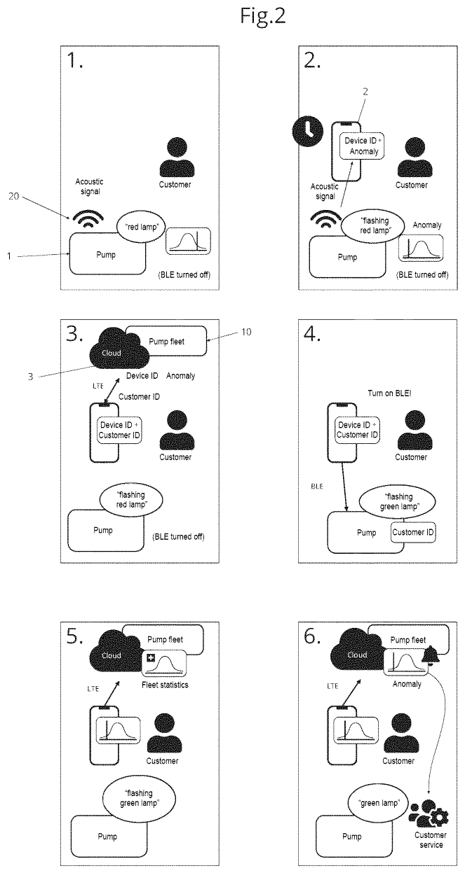

FIG. 2 shows a modified application scenario for the method according to the disclosure. In contrast to the first scenario according to FIG. 1, a fault occurs in the use-case according to FIG. 2 before the pump has been registered (“red lamp”). The pump 1 is here able to automatically recognize the anomaly even without being connected to the cloud 3. After the anomaly has been detected by the pump 1, the acoustic signal is used to draw the customer's attention to the pump 1. If the acoustic signal is recognized by the smartphone 2, the registration process should be carried out here too in order to link the unique DeviceID of the pump 1 with a CustomerID and thus allow customer-specific service to be provided.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

1-13. (canceled)

14. A method for information exchange between an external receiver and a pump comprising:
providing an electric motor as pump drive and a frequency inverter for the speed-regulated control of the motor, wherein the pump generates an acoustic information signal that is detectable by the external receiver; and
varying at least one operating parameter of the frequency inverter while the pump is operating normally, in such a manner that the pump, while it is operating normally, delivers an acoustic information signal that is detectable by the external receiver.

15. The method as claimed in claim 14, wherein the at least one operating parameter is the motor voltage generated at the output of the frequency inverter.

16. The method as claimed in claim 15, wherein via the frequency inverter, a higher-frequency voltage is modulated onto the motor voltage that is generated, said higher-frequency voltage, when the pump is operating, generating an acoustic signal that is detectable by the receiver.

17. The method as claimed in claim 14, wherein the operating parameter that is varied is the switching frequency of the integrated inverter of the frequency inverter, so that an acoustic information signal that is detectable during normal operation of the pump is generated.

18. The method as claimed in claim 17, wherein the information content of the acoustic signal is determined by the deviation of the varied switching frequency of the frequency inverter from an original switching frequency.

19. The method as claimed in either claim 17, wherein specific information, including an indicator or a binary value, is outputted by a defined deviation of the switching frequency from the original reference switching frequency.

20. The method as claimed in either claim 18, wherein specific information, including an indicator or a binary value, is outputted by a defined deviation of the switching frequency from the original reference switching frequency.

21. The method as claimed in 17, wherein the variation of the switching frequency takes place in a time-synchronized manner in order to allow a binary data sequence to be transmitted.

22. The method as claimed in 18, wherein the variation of the switching frequency takes place in a time-synchronized manner in order to allow a binary data sequence to be transmitted.

23. The method as claimed in 19, wherein the variation of the switching frequency takes place in a time-synchronized manner in order to allow a binary data sequence to be transmitted.

24. The method as claimed in claim 14, wherein the information contained in the acoustic information signal contains a state of the pump, including information on whether the pump is functioning properly.

25. The method as claimed in claim 14, wherein the information contained in the acoustic information signal indicates whether the pump has been registered.

26. The method as claimed in claim 14, wherein the external receiver records the operating noise of the pump via a microphone and extracts the transmitted information by audio signal analysis.

27. The method as claimed in claim 26, wherein the audio analysis comprises a fast Fourier transformation or a discrete Fourier transformation.

28. The method as claimed in claim 14, wherein the acoustic information signal is a signal that is perceptible to a human.

29. A centrifugal pump, comprising:
an electric motor; and
a frequency inverter for the speed-variable regulation of the electric motor, wherein the frequency inverter is configured to carry out the method as claimed in claim 14.
